(19) United States
(12) Patent Application Publication
(10) Pub. No.: US 2022/0081367 A1
(43) Pub. Date: Mar. 17, 2022

(54) THERMOSET CERAMIC COMPOSITIONS, INORGANIC POLYMER COATINGS, INORGANIC POLYMER MOLD TOOLING, INORGANIC POLYMER HYDRAULIC FRACKING PROPPANTS, METHODS OF PREPARATION AND APPLICATIONS THEREFORE

(71) Applicants: Vince ALESSI, Ann Arbor, MI (US); Reed SHICK, Midland, MI (US); Ahmad MADKOUR, Canton, MI (US); Julien Marchal, Ann Arbor, MI (US); Maryam Dehdashti, Ypsilanti, MI (US)

(72) Inventors: Vince ALESSI, Ann Arbor, MI (US); Reed SHICK, Midland, MI (US); Ahmad MADKOUR, Canton, MI (US); Julien Marchal, Ann Arbor, MI (US); Maryam Dehdashti, Ypsilanti, MI (US)

(21) Appl. No.: 17/391,177

(22) Filed: Aug. 2, 2021

Related U.S. Application Data
(63) Continuation-in-part of application No. 16/190,635, filed on Nov. 14, 2018, now abandoned.
Application No. 16/190,635 is a division of application No. 14/831,154, filed on Aug. 20, 2015, now abandoned.
Application No. 14/831,154 is a continuation of application No. 13/832,328, filed on Mar. 15, 2013, now abandoned.
Application No. 13/832,328 is a continuation of application No. 62/039,599, filed on Aug. 20, 2014.
Application No. 62/039,599 is a continuation of application No. 62/040,125, filed on Aug. 21, 2014.
Application No. 62/040,125 is a continuation of application No. 62/040,655, filed on Aug. 22, 2014.
(60) Provisional application No. 61/749,417, filed on Jan. 7, 2013.

(51) Int. Cl. C04B 35/52; C01B 33/00; C09K 8/80; B29C 39/22; B29C 39/02; C09D 183/00; C23C 18/12; C23C 4/129; C23C 4/134; C04B 28/00; C04B 28/26; C04B 12/04; C23C 4/04; C23C 24/08; B05D 3/00; B05D 7/24; B28B 1/14; B29C 33/02; B29C 33/04; B29C 33/38; B29C 33/40; B29C 45/37; B29C 45/73; C04B 35/04; C04B 35/057; C04B 35/10; C04B 35/14; C09J 5/06; E21B 43/26; C04B 14/02; C04B 14/04; C04B 14/06; C04B 14/10; C04B 14/22; C04B 14/30; C04B 14/38; C04B 14/42; C04B 16/06; C04B 18/08; C04B 22/00; C04B 22/06; C04B 24/20; C04B 24/32; C04B 40/06

(52) U.S. Cl. CPC C04B 35/52; B29K 2101/00; C09K 8/805; B29C 39/22; B29C 39/02; C09D 183/00; C23C 18/1216; C23C 18/1254; C23C 18/127; C23C 4/129; C23C 4/134; C04B 28/005; C04B 28/008; C04B 28/26; C04B 12/04; C09K 8/80; C23C 4/04; C23C 24/082; B05D 3/007; B05D 7/24; B28B 1/14; B29C 33/02; B29C 33/04; B29C 33/3842; B29C 33/40; B29C 45/37; B29C 45/73; C04B 35/04; C04B 35/057; C04B 35/10; C04B 35/14; C09J 5/06; E21B 43/26; C04B 14/022; C04B 14/041; C04B 14/043; C04B 14/06; C04B 14/106; C04B 14/22; C04B 14/303; C04B 14/38; C04B 14/42; C04B 16/06; C04B 18/08; C04B 22/0013; C04B 22/062; C04B 22/066; C04B 24/20; C04B 24/32; C04B 40/065; C01B 33/00

(57) ABSTRACT

Thermoset ceramic compositions and a method of preparation of such compositions. The compositions are advanced organic/inorganic hybrid composite polymer ceramic alloys. The material combines strength, hardness and high temperature performance of technical ceramics with the strength, ductility, thermal shock resistance, density, and easy processing of the polymer. Consisting of a branched backbone of silicon, and alumina, with highly coordinated Si—O—Si or Al—O—Al bonds, the material undergoes sintering at 7 to 300 centigrade for 2 to 94 hours from water at a pH between 0 to 14, humidity of 0 to 100%, with or without vaporous solvents.

### CROSS-REFERENCE TO RELATED APPLICATIONS

This application claims priority from U.S. patent application Ser. No. 14/831,154, filed Aug. 20, 2015, currently pending, which is a continuation utility patent application having Ser. No. 13/832,328, filed Mar. 15, 2013, currently pending, which is a utility patent application from U.S. Provisional application Ser. No. 61/749,417, filed Jan. 7, 2013, and, U.S. Provisional patent applications Ser. No. 62/039,599, filed Aug. 20, 2014, U.S. Provisional patent application 62/040,125, filed Aug. 21, 2014, and U.S. Provisional patent application Ser. No. 62/040,655, filed Aug. 22, 2014.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

What has been discovered are new compositions of matter, including coatings, mold tooling and hydraulic fracking proppants, and novel methods of preparing such compositions and applications.

In a first embodiment, there is a material that is a family of advanced inorganic polymer ceramic. Materials that are currently used in the art today include those found in “Modified Geopolymer Composition, Processes and Uses, disclosed in EP 2438027 A2, “Composition for Sustained Drug Delivery Comprising Geopolymeric Binder, disclosed in U.S. Patent publication 2012/0252845 A1. “AlC/Al12O3 Composites That Are Sintered Bodies and Method of Producing the Same” is disclosed in EP 0311289 B1. In addition, others have been disclosed in “Geopolymer Composition and Application in Oilfield Industry”, U.S. Pat. No. 7,794,537; “A Novel Carbonated Calcium Aluminosilicate Material for the Removal of Metals From Aqueous Waste Streams”, Sixth International Water Technology Conference, IWTC 2001, Alexandria, Egypt; U.S. Patent publication 2011/0230339, U.S. Pat. Nos. 5,866,754; 5,284,513; 8,257,486; 7,655,202, 7,846,250, and 5,601,643. The compositions of this invention were not found in the prior art. In addition, the preparation processes were also not found in the prior art.

In a second embodiment, there are high performance coatings which are necessary to protect surfaces from corrosive materials, wear, electrical currents, heat flow and just plain looking ugly. Coating for corrosive materials include polymers such as fluorinated, Teflon® (DuPont), polyethylene or other inert materials. In some instances, ceramic coatings are used to protect from wear low energy coatings including ceramics, plastics, platelet materials or porous materials that hold and wick oil. Electrically insulating coatings can protect metal from electrical currents and include plastic, rubber, or ceramic coatings. Low heat transfer coatings include low emissivity paint, metals or ceramics and low conductivity coatings such as porous ceramics, sol gels, mineral wool coatings.

U.S. Patent publication 2013/0122207 deals with a method of forming ceramic coatings and ceramic coatings and structures that are prepared from aluminosilicate fiber coating from colloidal suspension, from pH stabilized aqueous suspensions.

WO 2010148174 A3 deals with precursor dispersions of silica calcium phosphate.

Ceramic coating from carrier liquids usually a ceramic sol, then filled with ceramic sol can be found in Canadian patent 2,499,559. This material requires a high temperature cure.

Chinese patent 101811890 deals with acid-resisting complex phase ceramic coated preparation methods. A slurry is brushed or sprayed by a spray gun on the surface of materials such as cement, concrete and the like to form an even coating and then, after heat treatment, an A1203/S02/SiC series anti-reversion complex phase ceramic coating is obtained.

European patent application publication EP0352246 relates to a ceramic composition adapted to form a coating on a metal, said coating being obtained by applying the composition in an aqueous slurry. The invention also relates to a method for preparing and applying the composition, the use thereof, and an internal combustion engine exhaust pipe coated with layers of the composition.

There is described therein a heat-insulating ceramic coating on a metal, characterized, in that, the composition comprises in % by weight:
10-50% of potassium silicate
10-50% of colloidal silica
5-40% of inorganic fillerz
1-25% of ceramic fibers
2-40% of water
2-20% of hollow microparticles
0-5% of surface active agent.

When the composition according to the invention is to be used as a heat-insulating coating on an internal combustion engine exhaust pipe, it is applied in viscous water-slurried form by a so-called “pouring through” technique, i.e. the slurry is poured through the pipe to form a coating, dried at 50-150° C. for 0.5-3 hours and at 150-300° C. for 0.5-2 hours, optionally followed by one or more further drying cycles, whereupon the procedure is repeated from 2 to 5 times, preferably 3 times.

In EP publication 0781862 there is described a mix of ceramic and mineral particles suspended in an aqueous solution of sodium silicate. The sodium silicate preferably has a silica-to-sodium oxide ratio between 2.5 and 3.8 and comprises about 20%-40% of the aqueous solution. When the SiO2/NaO ratio falls below about 2, adhesive bonds are weaker, and they are very water sensitive. When the SiO2/NaO ratio is above about 4, crazing or microcracking of the coating occurs. A suitable commercially available mixer is effective for mixing the particles into the solution. In laboratory tests ½-gallon batches were mixed with a KitchenAid® K5SS mixer. The particles comprise about 40% to about 48% by weight of the slurry and the balance sodium silicate solution. A slurry of the most preferred particle mix and silicate solution yields a finished coating comprising about 25% magnesia, about 66% unfused silica, about 7% aluminum oxide, about 6% sodium oxide, and the balance impurities derived from the mineral particles.

A method of forming a radiopaque coating on an integrated circuit is described in EP 0684636 comprising applying a coating composition comprising a silica precursor resin and a filler comprising an insoluble salt of a heavy metal onto the surface of an integrated circuit, wherein the coating composition is selectively applied such that the bond pads to be used for interconnection, and the streets are not coated, and, heating the coated integrated circuit to a temperature between 50 to 1000° C. for up to 6 hours to convert the coating composition into a ceramic coating.

A method for forming a ceramic coating on an electrically conductive article is disclosed in EP 1606107, the method comprising immersing a first electrode comprising said electrically conductive article in an electrolyte comprising an aqueous solution of a metal hydroxide and a metal silicate; providing a second electrode comprising one of the vessel containing the electrolyte or an electrode immersed in the electrolyte; passing an alternating current from a resonant power source through the first electrode as an anode and to the second electrode as a cathode while maintaining the angle φ between the current and the voltage at zero degrees, and while maintaining the voltage between the first and second electrodes within a predetermined range.

A coating admixture, method of coating and substrates coated thereby is disclosed in WO 2005026402, wherein the coating contains colloidal silica, colloidal alumina, or combinations thereof; a filler such as silicon dioxide, aluminum oxide, titanium dioxide, magnesium oxide, calcium oxide and boron oxide; and one or more emissivity agents such as silicon hexaboride, carbon tetraboride, silicon tetraboride, silicon carbide, molybdenum disilicide, tungsten disilicide, zirconium diboride, cupric chromite, or metallic oxides such as iron oxides, magnesium oxides, manganese oxides, chromium oxides, copper chromium oxides, cerium oxides, terbium oxides, and derivatives thereof. In a coating solution, an admixture of the coating contains water. A stabilizer such as bentonite, kaolin, magnesium alumina silicon clay, tabular alumina and stabilized zirconium oxide is also added.

U.S. patent publication 2013/0122207 discloses using lower pH stabilized systems.

WO 2010148174, ceramic coatings, and Applications hereof discloses similar applications and end goals, but different chemistry.

Protective Ceramic Coatings disclosed in Canadian patent 2499559 deals with ceramic coatings from carrier liquids, usually a ceramic sol, which is filled with a ceramic sol.

Chinese patent 101811890 deals with a slurry reactive coating of Al203/SO2/SiC.

Ceramic Coating on metal shown in EP 0352246 shows similar starting materials but different reactive phases. The publication is silica centric, and the instant invention uses alumina silicate. The patentees dry their product, if the instant invention product dries prior to reaction; a very different end-product is obtained.

Other prior art includes Coated Exhaust Manifold and Method shown in EP 0781862. The patentees use similar starting materials, but magnesia is very high; Method of Applying Opaque Ceramic Coatings Containing Silica shown in EP 0684636 uses only Silica chemistry with similar reactive conditions; Composite Articles Comprising a Ceramic Coating shown in EP 1606107 discloses an Electrolytic coating with similar starting materials and a different reactive path, and Thermal Protective Coating for Ceramic Surfaces shown in WO 2005/026402 is a ceramic low emissivity coating with low emissivity (low e) additives.

In a third embodiment there is an inorganic polymer mold tooling. In WO2005/113210A2 there is disclosed a Method of Producing Unitary Multi-Element Ceramic Casting Cores and Integral Core/Shell Systems. In U.S. Pat. No. 7,270,166, there is disclosed a method of fugitive pattern assembly.

Wise, S. and Kuo, S., “A Cementitious Tooling/Molding Material-Room Temperature Castable, High Temperature Capable,” SAE Technical Paper 850904, 1985, doi:10.4271/850904 deals with DASH 47® a Cementitious composite initially formulated for use as an autoclave molding/tooling material. A unique matrix and aggregate system imparts unusually high strength and excellent vacuum integrity to DASH 47 at moderately high temperatures even though DASH 47 molds are cast at ambient temperature over commonly used pattern materials. This paper reviews the formulation and properties of DASH 47 and outlines its fabrication method and curing schedule for thin-shelled autoclave tools. In addition, examples of other molding applications for DASH 47 are shown in this paper.

Additional disclosure can be found in Peter Hilton, CRC Press, Jun. 15, 2000, Technology & Engineering—288 pages, 2 Reviews.

A discussion of the rapid tooling (RT) technologies under development and in use for the timely production of molds and manufacturing tools. It describes applications within various leading companies and guides product and manufacturing process development groups on ways to reduce investments of money and time.

Castable ceramic tooling for rapid prototyping includes chemically bonded ceramics. Ceramic used as backing for thin metal mold face or as mold itself.

U.S. Pat. No. 5,470,651 discloses a nickel shell with ceramic or polymer matrix filler for composites and surface coatings.

The present invention is unique from existing prior art in both its fundamental composition of matter, and perhaps more notable, its mechanism of synthesis. The reaction pathway by which the disclosed material is obtained proceeds through first the dissolution of the amorphous silicon, alumina, and alkali metal, for example, LiOH, in an alkaline solution co-solvated with one or more polar aprotic or protic solvents. The resulting solution/slurry rapidly has a viscosity between 300 and 100,000 centipoise.

This solution hardens into a gel-state as a result of silanol condensation complimented by cationic stabilization of the free labile anionic network forming elements (Al, Si, O). The physical properties of this gel state, and the states immediately preceding it, are largely a function of the relative concentration of divalent cations: monovalent cations to network forming elements (Al, Si, O).

This gel is stable from several minutes to several months, after which it will undergo dehydration-mediated shrinkage and cracking. The gel state is then subjected to curing at elevated temperatures and humidity, consisting of various pH water and solvents, at various pressures. During this curing, the reactivity of the system increases as solvolysis of the gel system recuperates alkalinity of the system, re-dissolving the silanol condensation product to a greater or lesser extent, and mediating a complete amorphous structure formation of the network forming elements (Al, Si, O).

The added heat of the system overcomes the endothermic barrier preventing the network forming reactions from taking place previously. Al and Si are bound via bridging oxygen generated via hydrolysis, which consumes alkalinity of the gel. The fundamental monomer of the reaction may be any variation of O, Al, and Si. More mono-cationic species will lead to a less polymeric and generally weaker structure, whereas divalent cationic species serve to create an even greater degree of crosslinking. Ca++ and Mg++ are less preferable due to their tendencies to rapidly form hydrates which often do not re-dissolve in the second phase of the reaction.

In another embodiment there are Proppants that are materials that are injected into hydraulically fractured oil and gas wells to “prop open” the fissures that are created during fracturing. Proppants must be transportable through injection media to the fissures, deposit appropriately throughout the fissure, and be strong enough not to “crush” under pressure from the walls of the fissure. They must also have a spherical geometry that creates a porous bed for the released oil and gas to permeate through the proppant (called ‘conductance’) and be collected at the well's surface. Today's proppants are typically sand, coated sand, clay-based ceramics (intermediate grades are the vast portion of the market), or sintered bauxite (high-value proppants).

As hydraulic fracturing is being utilized in deeper and more complex wells, the need has emerged for proppants with higher crushing strength and a consistent spherical shape versus sand to enhance proppant transport and conductivity. This has caused ceramics to rapidly grow to 30% of the market versus cheaper sands.

All proppants eventually fail as the rock structure crushes the proppants. Conductivity in the formation is critical to maintain production. As proppants fail, if they shatter into many small fines, the fines fill in the fracks and cut off conductivity.

Yet current ceramics present their own limitations. One of the biggest problems with ceramic proppants is their high density. For efficient fracturing and propping, the difference between the density of the proppant and the fracking carrier fluid must be as small as possible. Ceramic proppants have specific gravities between 2.4 and 3.4 g/cc, and thus require dense gel fracking. However, these gel fracking fluids create much smaller fractures, potentially negating the increased efficiencies provided by the use of proppants. The alternative is to use lightly modified water, called“Slickwater”, which makes larger fissures and uses fewer chemical additives. However, Slickwater has a low density and is therefore a poor carrier for ceramic proppants, resulting in a tradeoff between fracture size and proppant efficiency. A strong but low-density proppant available in large quantities has been described as “the holy grail” of the industry.

Another issue with current ceramic proppants is pellet production methods that often use a ‘tumble forming’ mechanism to achieve a spherical geometry. The unfortunate side effect of this method is that it imparts the proppant particle with a relatively rough surface that impinges flow throughout the fracture due to inter-particle friction. Continuous abrasive contact from these rough surfaces can damage equipment and even the well itself.

Inorganic polymers have demonstrated physical strength properties similar to those of the most widely used ceramic proppants, but with a density of 1.6 g/cc or a 30% reduction in density. Using existing pelletizing technologies, spheres with a significantly smoother surface versus today's ceramic proppants can be manufactured in large volumes.

In the Slickwater fracturing processes the industry is adopting, we believe that the combination of lower density and smoother surface will create a proppant that can be transported with greater efficiency and control versus today's ceramics. The result is a proppant of significantly higher value due to the increased conductivity that enables greater production from a given well.

Raw materials for inorganic polymer proppants are available local to major fields in the form of industrial waste streams and by-products.

Possible groundwater contamination has been identified and/or reported in communities proximate to water tables with fracking-compromised aquitard formations. Due to the unique chemical composition and controlled porosity achievable by the inorganic polymer material, there is the potential to engineer inorganic polymer proppants so that they are able to absorb at least some of the reactive aromatic hydrocarbons, which could otherwise leak through fracking-disrupted aquitards.

Inorganic polymers start as a two-part formulation optimized for proppant physical properties (crush resistance, smoothness of surface finish, low specific gravity) at minimal cost utilizing raw materials found close to major well regions.

U.S. Pat. No. 8,183,186 deals with a cement-based particulate and methods of use wherein the proppant that is formed is not pure inorganic polymer, but an aggregated material cemented together with an inorganic polymer to form a proppant. The reaction does not include aprotic solvent and therefore does not solvate and subsequently condense the inorganic oxides. Also, the cure conditions do not require retention of the solvent. Carbon is not included in the matrix. The resulting polymer is very brittle compared to the instant invention.

“First, Metakaolin geopolymer composite particulates were prepared from calcined metakaolin (average particulate size 4 micron) and MICROSAND™ (average size about 5 microns) were mixed in 3:4 ratio. A 1:1 weight % solution of 40% sodium silicate and 14 N sodium hydroxide (”NaOH“) in water was used as a binder. The material was agglomerated in an Eirich mixer at 1300 rpm and at high bowl speed. The amount of binder used was 25% the weight of the ceramic powder. In this embodiment, the metakaolin cementitious material is thought to react with sodium silicate and sodium hydroxide and form a geopolymer phase that binds that MICROSAND™ filler material. After agglomeration, the particles were cured at 100° C. for 24 hours in an air oven. The material was then sieved to obtain mostly 12/20 mesh spherical particulates.”

Publication WO2012055028A9 deals with alkali-activated coatings for proppants wherein the proppant comprises a particulate substrate and one or more layers of a coating around the surface of the particulate substrate, wherein the coating, excluding the composition of fillers and other auxiliary components, comprises an alkali-activated binder with a molar ratio of S1O2/Al2O3 ranging from 1 to 20.

Publication WO2012055028A9 deals with alkali-activated coating for proppants wherein the proppant formed is not pure inorganic polymer, but a coated core/shell material wherein the inorganic polymer is the shell of the proppant. The reaction does not include aprotic solvent and therefore does not solvate and thus subsequently condense the inorganic oxides. Also, the cure conditions are not required to retain the solvent. Carbon is not included in the matrix. The resulting polymer is very brittle compared to the instant invention.

Thus, this invention deals in one embodiment with hydraulic fracture proppants made from inorganic polymers, especially where the inorganic polymer consists essentially of bonds of aluminum oxide, silicon oxide, silicon carbide and combinations thereof.

### BRIEF SUMMARY OF THE INVENTION

Thus, what is disclosed and claimed herein in the first embodiment, is a composition of matter comprising a polymer of aluminum, silicon, and oxygen.

In another embodiment, there is a composition of matter provided by the incipient materials aluminum oxide, silicon oxide, protic solvent, and a source of divalent cations.

Yet, another embodiment is a composition of matter as set forth just Supra, which is a gel.

Still another embodiment is a method of preparation of a composition wherein the method comprises providing a mixture of aluminum oxide and silicon oxide and, providing a second mixture, having a basic pH, in a slurry form, of water, a source of OH, protic solvent, and a source of divalent cations.

Thereafter, mixing the materials together using shear force to form a stiff gel and thereafter, exposing the resulting product to a temperature in the range of 160° F. to 250° F. for a period of time to provide a thermoset ceramic.

Thus, what is further disclosed and claimed herein is a method of manufacturing a solid substrate having a protective coating on the surface thereof. The method comprises providing a blend of components for forming an inorganic polymer ceramic coating selected from the group of blends consisting of a. dry blends, and b. slurry blends, and providing a second liquid blend of components for forming an inorganic hybrid polymer ceramic coating, and then, blending them together to form a slurry.

Then, coating a predetermined solid substrate with the blend and placing the coated solid substrate into a chamber to prevent humidity loss, thereafter, curing the coated solid substrate at a temperature higher than 50° C. for a predetermined period of time to obtain a solid substrate having a protective coating on the surface.

Also contemplated within the scope of this invention is a protective coating prepared by the method set forth just Supra and a solid coated substrate when manufactured by the method.

In another embodiment, there is a mold tool having a composition comprising Al, Si, O amorphous or microcrystalline polymer composite and methods of manufacturing such tools.

In a further embodiment there are hydraulic fracture proppants manufactured from inorganic polymers.

### BRIEF DESCRIPTION OF THE SEVERAL VIEWS OF THE DRAWINGS

FIG. 1 is Raman peak at 1349 wave numbers (cm⁻¹) has a full width half height ratio of 0.12.

FIG. 2 is Raman peak at 1323 wave numbers (cm⁻¹) full width half height ratio is 0.16.

FIG. 3 is FTIR curves on examples 1 to 9.

### DETAILED DESCRIPTION OF THE INVENTION

The present invention is unique from existing prior art in both its fundamental composition of matter, and perhaps more notably, its mechanism of synthesis. The reaction pathway by which the material is obtained proceeds through first, the dissolution of the amorphous silicon, alumina, carbon, and alkali metal, in an alkaline solution co-solvated with one or more polar aprotic or protic solvents.

The resulting solution/slurry rapidly has a viscosity between 300 and 100,000 centipoise. This solution hardens into a gel-state as a result of silanol condensation complimented by cationic stabilization of the free labile anionic network forming elements (Al, Si, O). The physical properties of this gel state, and the states immediately preceding it, are largely a function of the concentration of divalent cations: monovalent cations: to network forming elements (Al, Si, O).

This gel is stable for a time period of several minutes to several months, after which it will undergo dehydration-mediated shrinkage and cracking. The gel state can then be subjected to curing at elevated temperatures and humidity, consisting of various pH water and solvents, at various pressures. During this curing, the reactivity of the system increases as solvolysis of the gel system recuperates alkalinity of the system, re-dissolving the silanol condensation product to a greater or lesser extent, and mediating a complete amorphous structure formation of the network forming elements (Al, Si, O).

The added heat of the system overcomes the endothermic barrier preventing the network forming reactions from taking place previously. Al and Si are bound via bridging oxygen generated via hydrolysis, which consumes alkalinity of the gel. The fundamental monomer of the reaction may be any variation of O, Al, and Si. More mono-cationic species will lead to a more polymeric and generally weaker structure, whereas divalent cationic species, preferably Li serve to create an even greater degree of crosslinking. Ca++ and Mg++ are less preferable due to their tendencies to rapidly form hydrates which often do not re-dissolve in the second phase of the reaction.

This material differs from geopolymers, in that, geopolymers consist of Al—O—Si networks and are generated via a one-step solvent-free method and produce materials of vastly inferior strength. The geopolymer matrix is not modified by protic or aprotic solvents.

Geopolymers have been mixed with latex, acrylates, and ethylene vinyl acetate (hydrophilic hydrocarbon polymers). However, in these situations these polymers interface with the geopolymer only though a bridging O group via reduction of one of the polymer free hydroxyl or other electronegative reactive groups. There is no continuous integration of carbon into the geopolymer matrix itself, and the hydrocarbon polymer very much retains its molecular identity throughout the reaction and serves mainly as a stabilizer of what is a relatively flawed silyl-silanol condensation polymer.

Some geopolymers have been developed with unique porosity such that hydrocarbon containing or comprised molecules can be retained within them, thereby turning the geopolymer into a drug delivery mechanism. However, these compounds have no structural modifications of the geopolymer matrices, and thus are even farther from the presently disclosed invention than the geopolymer-glue materials previously mentioned. The case of geopolymers used in oilfields is similar in the ab/adsorption of carbon containing compounds onto/into the (porous) geopolymer in a fashion proportional to the surface area of the geopolymer particle.

The instant invention differs from the prior art. The instant invention has a composition including Si, Al, O end-capped with a divalent cation such as Mg which is not found in the prior art literature. The instant invention is a two-step process of forming a hydrogel followed by recombination oxygen crosslinking, all of which is not found in the prior art literature.

The present invention is unique from existing prior art in its mechanism of synthesis. While not bound by any particular theory, the reaction pathway by which the disclosed material is obtained proceeds through (1.) the dissolution of the amorphous silicon, alumina, carbon, and alkali metal, for example, LiOH, NaOH, or KOH, in an alkaline solution co-solvated with one or more polar aprotic or protic solvents. The resulting solution/slurry rapidly has a viscosity between 500 and 700,000 centipoise. (2.) This solution hardens into a gel-state as a result of silanol condensation complimented by cationic stabilization of the free labile anionic network forming elements (Al, Si, O).

The physical properties of this gel state, and the states immediately preceding it, are largely a function of the relative concentration of divalent cations: monovalent cations to network forming elements (Al, Si, O). This gel is stable from between several minutes to several months, after which, if allowed to dry, will (3.) undergo dehydration-mediated shrinkage and cracking. The gel state is then (4.) subjected to curing at elevated temperatures and humidity, consisting of various pH water and solvents, at various pressures.

During this curing, the reactivity of the system increases as solvolysis of the gel system recuperates alkalinity of the system, re-dissolving the silanol condensation product to a greater or lesser extent, and mediating a complete amorphous structure formation of the network forming elements Al, Si, and O.

The added heat of the system overcomes the endothermic barrier preventing the network forming reactions from taking place previously. Al and Si are bound via bridging oxygen generated via hydrolysis, which consumes alkalinity of the gel. The fundamental monomer of the reaction may be any variation of O, Al, and Si.

More mono-cationic species will lead to a more polymeric and generally weaker structure, whereas divalent cationic species, preferably Li, serve to create an even greater degree of crosslinking. The cations, Ca++ and Mg++ are less preferable due to their tendencies to rapidly form hydrates which often do not re-dissolve in the second phase of the reaction.

The inventors herein have discovered a method to produce a new class of inorganic polymer ceramic-like materials useful in coatings, and methods to apply them. The polymers and their methods of preparation can be found in U.S. patent application Ser. No. 13/832,328, filed Mar. 15, 2013. The coatings are useful as a corrosion resistant coating, low friction coating, electrically insulating, low heat transfer coating or aesthetic coating. The coating may be applied as a spray, electro spray, dip, brush, rolled on, flow coated or reacted in place. The coating is especially useful as a pipe coating both interior and exterior.

The inventors herein have developed a family of advanced inorganic polymer ceramics to replace high performance coatings. These polymer materials can be euphonically described as a thermoset ceramics. The material combines strength, hardness and high temperature performance of technical ceramics with the strength, ductility, thermal shock resistance, density, and easy processing of a polymer. The unique chemical structure of the polymer materials provides enhanced strength properties and decreased density with tailored physical, electromagnetic, and thermoconductive properties.

The inventors herein have discovered a class of materials and methods to coat parts to form controlled porosity, thermal conduction, emissivity, surface hardness, flexibility, toughness, elongation, electrical conduction, density, and electromagnetic properties.

Due to the highly tailorable nature of the materials' properties, its compatibility with functional additives, ease of fabrication, and high strength-to-weight ratio, there are many applications to which it can be applied. HCPC formulations can be customized to provide system components that are not only application-tailored in their shape, but in their physiochemical properties as well. In addition to the versatility in terms of manufacturing parts and components from the material itself, the material also has several applications for use in the coating industry.

The chemical inertness and temperature resistance of the material to 34000 f allows it to be used to coat both nonferrous and ferrous metals and metal alloys. Due to its high dimensional stability at high temperatures, and low reactivity, the material could allow a disruptive innovation in allowing steel to be made non-corroding, low friction, low electrical and heat conducting.

The tailorable thermal conductivity of the material is of especially great interest.

The polymer material is processed as a reactive two-part material, similar to epoxy, during the fabrication process. The material as mixed can have a viscosity from 500 to 75,000 cPS. The lower viscosity is better for spraying thin films, while the higher viscosity is suitable as a rolled out thin sheet and applied directly. The spray techniques may include air spraying, airless spraying, electro spraying, rotary cone spraying, ultrasonic spraying, and the like.

The initial reaction is the formation of a semi-solid gel state. The final cure reaction occurs when the ‘gel state’ part is exposed to temperatures of 160-250° F. for 2-6 hours. Longer curing times yield stronger materials. This cures the polymer to an advanced ceramic-like state. Shrinkage is in the range of less than 0.01%, allowing very fine tolerances. A molecularly smooth surface allows for low-cost high performance, rapid, complex parts manufactured with excellent surface texture. The texture may be smooth and high gloss or may be made with a matt finish as desired. The advanced hybrid is a suitable alternative for critical and strategic coatings.

The materials have several readily apparent dimensions of appeal.

Its composition can be composed of available refined feedstocks and can optionally include various quantities of USA-sourced technical grade postindustrial waste stream materials, offsetting both bulk material costs and decreasing environmental impact of formulations.

The materials contain no heavy metals, thus mitigating personnel safety risk.

The materials have multiple end use applications such as, coatings, varnish, veneer, polish, stain, colorant, heat/radiation shields, coatings and sprays; Reflective and ablative; Insulators, Conductors, semiconductors; thermal cycling modules, abrasion resistant wear components; heat radiation substrate; heat/abrasive/caustic/acidic material resistant pipes and linings; thermal and electric insulators; covers; heat shields; can coatings; tank linings; and pipe coatings and linings.

With regard to the use of the compositions herein as proppants, the inorganic polymers of this invention have demonstrated physical strength properties similar to those of the most widely used ceramic proppants, but with a density of 1.7 g/cc. Using existing pelletizing technologies, spheres with a significantly smoother surface versus today's ceramic proppants can be manufactured in large volumes. The density of the proppant can be reduced by either foaming the polymer or by filling with low density materials. Any desired density, including to 1.0, may be obtained by foaming or filling the polymer to match the fracking fluid density needs.

In the Slickwater fracturing processes adopted by today's industry, it is believed that the combination of lower density and smoother surface will create a proppant that can be transported with greater efficiency and control versus today's ceramics. The result is a proppant of significantly higher value due to the increased conductivity that enables greater production from a given well.

Raw materials for inorganic polymer proppants are available local to major fields in the form of industrial waste streams and by-products, clays, mineral or metal oxide deposits.

Possible groundwater contamination has been identified and/or reported in communities proximate to water tables with fracking-compromised aquitard formations. Due to the unique chemical composition and controlled porosity achievable by the inorganic polymer material, there is the potential to engineer inorganic polymer proppants so that they are able to absorb at least some of the reactive aromatic hydrocarbons, which could otherwise leak through fracking-disrupted aquitards.

Ceramic proppants exhibit brittle failure when crushed shattering resulting in a large fraction of fines. Inorganic polymers can be designed to include significant flexibility. There are several ways to increase flexibility of the inorganic polymer proppant. Plasticizers, reduced polymer branching, inclusion of fibers all significantly increase the flexibility of the inorganic polymer.

The resulting proppants can deform to resist fracture. Also, when fracture does occur, they break into large pieces with few, if any, fines. Conductivity of the formation is maintained and not blinded by the fines. Adding of fibers to ceramic proppants is known (Schlumberger).

Polymers can be formed by any known granulation processes. Nominally spherical proppants are desired; however, different shapes have value for specific applications. Elliptical proppants have been shown to increase conductivity in a given formation (Baker Hughes). Cylindrical proppants are desired as “proppant pillars” for high compression resistance (Halliburton). The curing conditions of less than 200 oF is very low energy compared to traditional ceramic proppants.

### EXAMPLES

The carbon compound(s), solvents, and alkaline solutions, with waterglass, are blended under agitator-level mixing conditions until a uniform solution is achieved. The dissolution of the carbon at room temperature is negligible, and as such the solution will be pitch black and gently roiling due to evaporative convection. As such, a lid should be placed on the vessel. As this stage, oligomerizing metalloorganic materials may be added in trace quantities. These compounds, such as vinyltrimethoxysilane serve to “seed” oligomeric structures which produce materials with differing strength, thermal, conductivity, and other properties. The solution may be heated in a pressure-sealed vessel to ensure dissolution of the materials. Upon cooling, remaining pressure may be released and excess solvent may need to be added. This breaching step is of importance to mention only since certain metalloorganic evolve gasses in the presence of alkaline water. Organic polymer precursors, such as phenol and furan containing compounds, can be added at this step. The solution is best kept at cool temperatures.

The metal salt powder blend is prepared through the addition of Alumina as amorphous A1203 anhydrous, amorphous alkali silicoaluminate source such as low-calcined Kaolin clay or Spodumene, amorphous SiO2 in the form of glass flour or fumed silica. It is also advantageous to add powdered LiOH or KOH to this powder mix to compensate for any neutralization of the solution previously disclosed through absorption of CO2 into the solution. Once all powders have been combined, they must be put through a blending and de-agglomeration step, due to the anhydrous material's tendency to clump together. Once de-agglomerated and thoroughly blended, it should be sealed such that no moisture can access it.

Alternatively, recycled waste stream material may be added: aluminosilicate sources such coal combustion products (e.g., Fly Ash) or metal refining by products (ground blast furnace slag, silica fume), rice husk ash, municipal sludge ash, etc. In this case, the relative cationic concentrations must be carefully monitored and calculated and balanced. Alternatively, the Al2 O3 can be introduced to the liquid material.

According to these examples, approximately 90-95 grams of liquid is combined with 170-190 grams of the reactive powder mixture. The powder must be added to the liquid gradually or under very high shear to ensure forced reaction constituent proximity necessary to engage the first step of the reaction. If this directive is not followed, insufficient ‘wetting-out’ of the powder will occur, and the reaction will be ruined. If the mixing is occurring in a sealed kettle, the liquid component may be heated up to 60 degrees centigrade to aid in rapid dissolution and therefor hasten system throughput. Powdered caustic potash or LiOH will be of benefit as they will dissolve into the mixture as the hydrolysis of the amorphous reactive constituents consume the alkalinity of the system, maintaining a critical level of free C, Si, and Al ions.

This solution should be cooled and then undergo ultrahigh shear mixing, such as a rotostator pump or mixer, to ensure all reactive species have reacted. The more homogenous the solution/nanoslurry, and the less metalloorganic oligomerizing agents present, the more amorphous the structure eventually formed will be. It is suggested that this step be cooled due to the excessive heat often generated by high shear systems. If a high shear mixer is lacking, a twin auger mortar mixer could suffice, though the mixing vessel should be located in an ice bath.

Following high shear mixing, the solution/nanoslurry can have fibers and or other bulking and or functional additives placed into it. Due to the preference of the material for amorphous structures, glass fibers and carbon fibers may be added and expectedly produce a much stronger material than neat. Steel fibers are also an excellent choice due to their potential to be oxidized and form strong oxygen bridges with Al and Si, and rarely, oxycarbide groups. Alternatively, the slurry may be used to wet out a continuous fiber matrix. Any particulates added must be pre-wetted with a alkaline solution or they will destroy the viscosity of the material. Viscosity of the neat material can be altered through increasing the concentration of divalent cations over any monovalent cations present; the former form ionic stabilized gel that can reach the consistency of clay if so desired (e.g., extrusion). The recipes provided have roughly the consistency of cake batter and may be injection cast or molded with ease. It manifests thixotropic behavior such that in-line vibration-aided de-airing would remove bubbles left in the matrix.

The material will take between 5 and 20 minutes to reach a demoldable state if left at the presumptively cooled state it was injected in. If the mold is heated, the demolding time can be decreased by a scale of magnitude, but care must be taken to ensure that proper solvent-moisture level is maintained in the matrix. This is not a difficult task, as the nano-porous nature of these particular mixtures makes them resilient to “dry out”.

Once demolded, the gel-state material is stable for 3 hours at room temperature at 20% humidity and 72° F. If refrigerated at 40 degrees, placed inside a non-porous/reactive plastic bag with water between pH 8 and 9, the gel state is stable for several days. At any point during this time, the material can be milled, tooled, etc. If the mixture is sufficiently de-aired, there will be minimal, though potentially noticeable under microscopic scrutiny, differences between the cast and the milled surfaces. This is largely determined by the tool used to mill the material.

The provided formulations are such that they are to be cured at saturated humidity between pH 2 and 10, 165° F., for 6 hours at least, preferably 6 hours or more. Following that, the material should be allowed time to breathe for as long as possible before being put under maximum stress loads. This allows the remaining reaction solution to crystalize within the pores, creating a silicaceous polished surface appearance on the surface of the material. Depending on the solvent used and the level of dissolution of carbon compounds, this layer may or may not have different conductive properties than the primary matrices. Should the material be destined for metal casting applications, desiccation of the material would be advantageous to prevent the production of supercritical steam when the molten metal hits an improperly ‘breathed’ patch of the material.

It is noteworthy that the material does not seem to ever stop gaining strength, though the rate of strength gain does seem attenuate at a logarithmic rate. Nonetheless, several months old samples are significantly stronger than their younger counterparts. Materials of unprecedented strength could likely be obtained through curing regimes of several months.

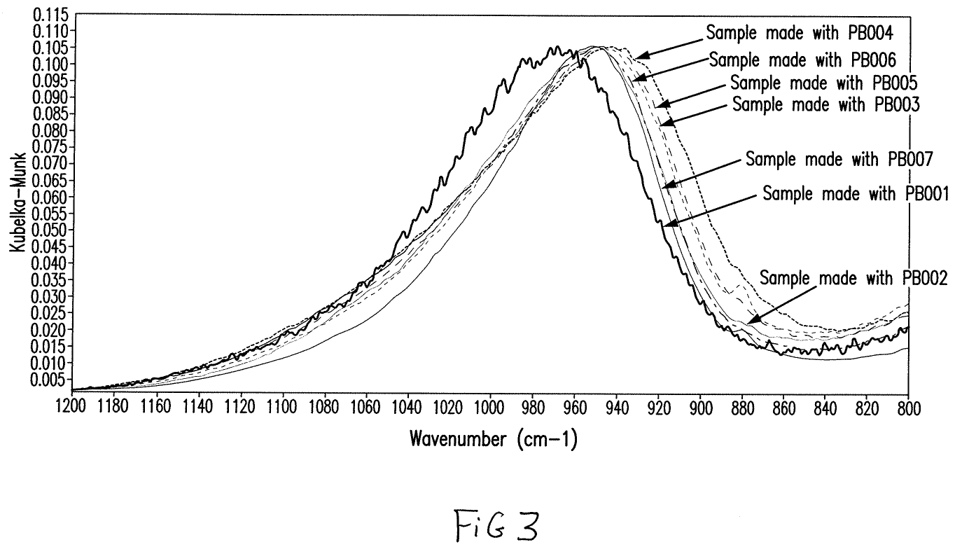

FIG. 3 is example 1 and FIG. 4 is example 2.

The composition formed is an amorphous polymer of silicon and aluminum with oxygen bonds. Raman spectroscopy is one way to measure the amorphous nature and observe the bonds present. Crystalline materials exhibit relatively shape bands and harmonic repetition of bands. The inventive materials are characterized by wide diffuse bands with a lack of harmonics. The silicon oxygen bridge between 1300 and 1400 wave numbers in the instant samples have a full width half height normalized ration from 0.12 to 0.16.

### Example 3

Proppants are materials that are injected into hydraulically fractured oil and gas wells to “prop open” the fissures that are created during fracturing. Proppants must be transportable through injection media to the fissures, deposit appropriately throughout the fissure, and be strong enough not to “crush” under pressure from the walls of the fissure. They must also have a spherical geometry that creates a porous bed for the released oil and gas to permeate through the proppant (called ‘conductance’) and be collected at the well's surface. Today's proppants are typically sand, coated sand, clay-based ceramics (intermediate grades are the vast portion of the market), or sintered bauxite (high-value proppants).

Examples were made according to the method of example 1 with the starting materials:

| Grams | Grams | Grams Carbon | Grams | Grams Part |
|---|---|---|---|---|
| Al(OH)3 | SiO2 | Black | MgO | B (pH 13.4) |
| 33.43 | 42.78 | 3.86 | 1.66 | 43.3 |

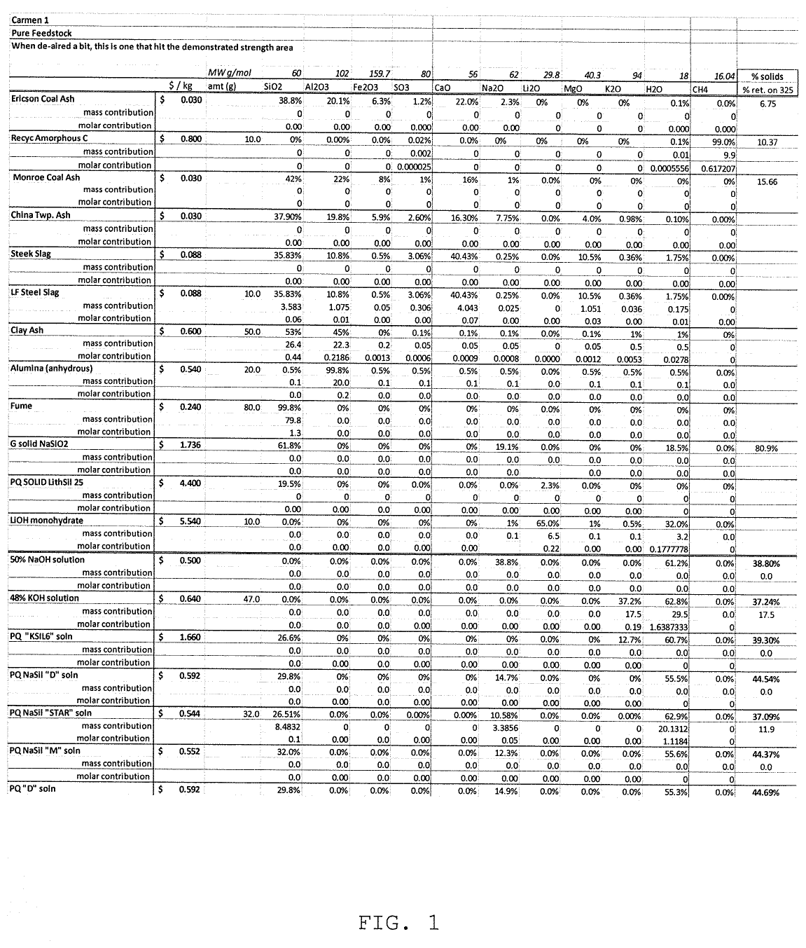

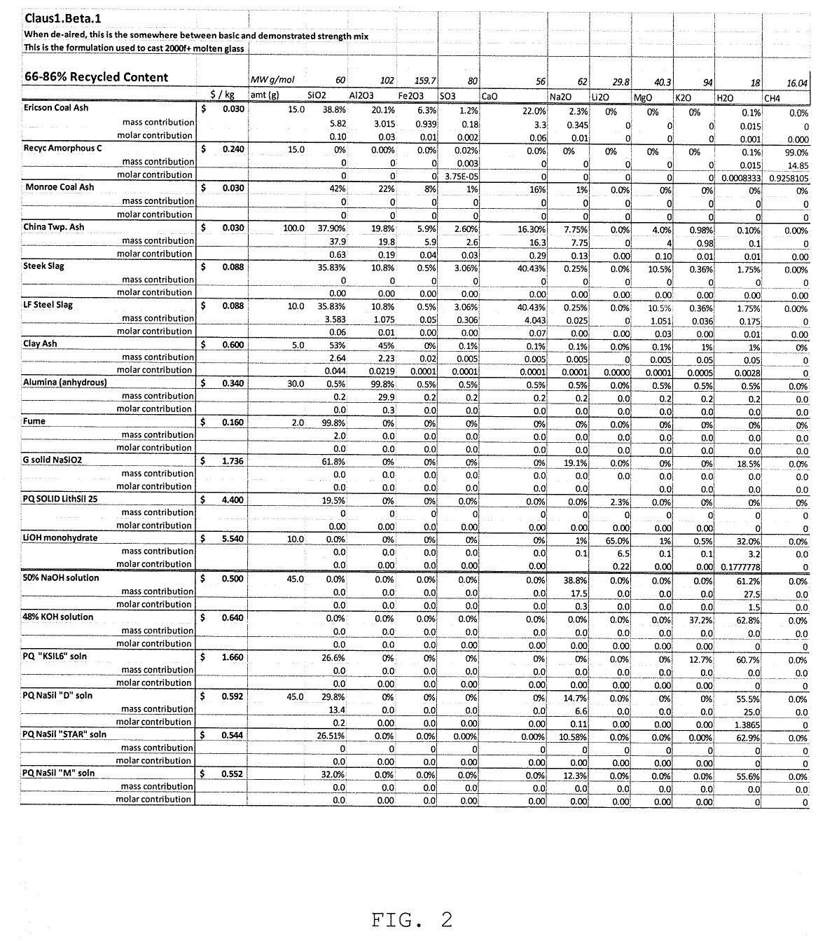

Part B is a solution of 20 g KOH 112 grams water glass, 20 g amorphous silicon, 12.5 grams methanol, 12.5 grams methylene glycol, and 4 grams formic acid. The Al(OH)3, SiO2, solvent and MgO were mixed as dry powder, then added with mixing to part B solution. The slurry was allowed to green set for 30 minutes, followed by curing in a 160-degree Fahrenheit oven for 12 hours. The cure step for example 3 being in air at 30% humidity and the cure step for example 4 in air at 100% humidity. Example 3 Raman peak at 1349 wave numbers (cm-1) has a full width half height ratio of 0.12. (See FIG. 1) Example 4 Raman peak at 1323 wave numbers (cm-1) full width half height ratio is 0.16. (See FIG. 2)

### Example 4

Emissivity measurements were made as follows. Three-inch diameter by ¼ inch thick cylindrical disks were cast and cured. The disks were painted with known emissivity flat black 0.95 emissivity, reflective metallic 0.30 emissivity and white 0.92. One quarter was left uncoated to measure native emissivity. The disk was heated with a 250watt heat light 12 inches from the disk for 5 minutes. A NBS calibrated IR thermometer was then used to measure the heat emitted from all four sections. The known emissivity measurements were linearized and used to calculate the emissivity of the native disk.

Thermal conductivity was measured by first, casting one inch diameter cylinders two inches long. The cylinders ends were polished. Standard materials of known thermal conductivity were similarly prepared. Standards included Aluminum, 1054 steel, borosilicate glass, graphite, and mullite. Thermocouples were attached to the top center and bottom outside edge of the cylinder. The thermocouples were attached to a data logger. The cylinder was placed on a hot plate set at 150 degrees C. The heating rate and differential from top to bottom of sample was measured. The known materials differential vs conductivity were fitted to an exponential decay and the thermal conductivity of the sample was calculated.

Delta T Watt/mK

ANSI A137.1, is called the DCOF Acutest for dynamic coefficient of friction of ceramics. The formula is μ=f/N, where μ is the coefficient of friction, f is the amount of force that resists motion, and N is the normal force. Static friction is below 0.30 and dynamic below 0.15.

Acid, base and solvent resistance was measured by soaking samples of the thermal set ceramic in one-inch cubes in concentrated acid base or solvent for one month then drying and measuring any weight gain or loss.

Dry Blend Solid Materials Part A
40 g calcium alumina silicate
22 g alumina silicate

22 g fly ash

Mix with Solution Part B
5 g methanol
14 g sodium hydroxide
0.25 ethylene glycol
2.7 g borax
1.9 g formalin
55.6g 40% sodium silicate solution

Mixed part A and B into a well dispersed solution. Slurry was applied as coating on substrates or cast into disks for thermal testing, then placed in enclosure to prevent humidity loss and cured overnight in a 77 oC oven. Measured emissivity 0.42.

### Example 5

Dry Blend Solid Materials Part A
15 g magnesium oxide
86 g alumina silicate
64 g fly ash
18 g aluminum tri hydrate
13 g sodium naphthalene sulfate
14 g ceramic nanospheres

Mix Solution Part B
7.9 g methanol
22 g Potassium hydroxide
2 ethylene glycol
4.1 g borax
3.8 g formalin
111 g 40% sodium silicate solution

Parts A and B were mixed into a well dispersed slurry. Slurry was applied as coating on substrates or cast into disks for thermal testing, then placed in an enclosure to prevent humidity loss and cured overnight in a 77 oC oven. Measured emissivity=0.82. Thermal conductivity=0.54 W/M2/sec.

### Example 6

Dry Blend Solid Materials Part A
15 g magnesium oxide
86 g alumina silicate
64 g fly ash
18 g aluminum tri hydrate
13 g sodium naphthalene sulfate
14 g ceramic nanospheres
40 g titanium dioxide

Mix Solution Part B
7.9 g methanol
22 g potassium hydroxide
2 g ethylene glycol
4.1g borax
3.8 g formalin
111 g 40% sodium silicate solution

Mixed part A and B into a well dispersed slurry. Slurry was applied as coating on substrates or cast into disks for thermal testing. Placed in enclosure to prevent humidity loss and cured overnight in 77 oC oven. Measured emissivity=0.54. Thermal conductivity=0.59 W/M2/sec.

| | | |
|---|---|---|
| Example 5 | 32.90 | 0.54 |
| Example 6 | 31.10 | 0.59 |
| Graphite | 5.32 | 33.7 |
| Borosilicate | 28.78 | 1.12 |
| Aluminum | 2.63 | 220 |
| Mullite | 11.86 | 2.5 |
| Steel | 5.23 | 51.9 |

### Example 7

Part A:

| | | |
|---|---|---|
| Fly Ash | 370 | g |
| Ground Glass Flour | 400 | g |
| Metakaolin | 290 | g |
| Sodium Naphthalene | | |
| Sulfonate | 8.5 | g |
| Magnesium Oxide | 12.6 | g |

Part B:

| | | |
|---|---|---|
| 40% Sodium Silicate | 556 | g |
| Potassium Hydroxide | 98.2 | g |
| Ethylene Glycol | 11 | g |
| Methanol | 20 | g |
| Methylene Glycol (37%) | 19 | g |

### Example 8

Part A:

| | | |
|---|---|---|
| Fly Ash | 370 | g |
| Ground Glass Flour | 400 | g |
| Metakaolin | 290 | g |
| Magnesium Oxide | 12.6 | g |

Part B:

| | | |
|---|---|---|
| 40% Sodium Silicate | 556 | g |
| Potassium Hydroxide | 98.2 | g |
| Ethylene Glycol | 11 | g |
| Methanol | 20 | g |
| Methylene Glycol (37%) | 19 | g |

### Example 9

Part A:

| | | |
|---|---|---|
| Fly Ash | 370 | g |
| Ground Glass Flour | 400 | g |
| Metakaolin | 290 | g |
| Sodium Naphthalene | | |
| Sulfonate | 8.5 | g |
| Magnesium Oxide | 12.6 | g |

Part B:

| | | |
|---|---|---|
| 40% Sodium Silicate | 556 | g |
| Potassium Hydroxide | 98.2 | g |
| Ethylene Glycol | 11 | g |
| Methanol | 20 | g |
| Methylene Glycol (37%) | 19 | g |
| 3 mm glass fiber | 8 | g |
| 300 micron carbon fiber | 50 | g |
| ¼ inch aramid fiber | 150 | g |

### Example 10

Part A:

| | | |
|---|---|---|
| Fly Ash | 370 | g |
| Ground Glass Flour | 400 | g |
| Metakaolin | 290 | g |
| Sodium Naphthalene | | |
| Sulfonate | 8.5 | g |
| Magnesium Oxide | 12.6 | g |

Part B:

| | | |
|---|---|---|
| 40% Sodium Silicate | 556 | g |
| Potassium Hydroxide | 98.2 | g |
| Ethylene Glycol | 11 | g |
| Methanol | 20 | g |
| Methylene Glycol (37%) | 19 | g |
| sodium borate (5 H2O) | 129 | g |
| 3 mm glass fiber | 8 | g |
| 300 micron carbon fiber | 50 | g |

For all examples:

Part A: all components are added and dry blended until uniform.

Part B is added sequentially with stirring each component one at a time in order, slowly to maintain a clear single-phase solution. Fiber was dispersed in the solution after all the other ingredients dissolved into a single phase.

Part A and B are added in a mixing cup at a ratio of 1:0.72 in a gyro mixer until well blended. The resulting slurry is then cast into a variety of useful shapes. The slurry cast was then placed in a container to prevent evaporation of the solvents and allowed to “green set” into the hydrogel at room temperature for two hours. The green set inorganic polymer was then removed from the mold. The green set inorganic polymer was then placed in a humidity-controlled oven at 180° F. for 12 hours for final cure.

The slurry was cast as a by inch disk for diametrical compression tensile strength measurement. Tensile strength of example 1 was 1029 psi with 7.9% elongation prior to fracture. Tensile strength of example 2, made without the plasticizer, was 1091 psi with 2.7% elongation prior to fracture. Tensile strength of example 3 with fiber was 1201 psi with 32% elongation prior to fracture.

The slurry of example 10 was cast as an injection mold halves into two 8 inch by 8-inch frame by 3 inch boxes with a wine cork mold half in each part and cured as above. The two mold halves were fit into a MUD frame and used on a plastic injection mold machine and thermoplastic urethane (TPU) parts made. Mold closing pressure was 110 tons, 3000 psi injection pressure.

### Example 1 through 9

11 different activators were prepared to make example 1 through 11.

TABLE x1
Composition of activators (part B) prepared for samples 1-11

| | | | Sodium | | | | Hexylene- | Ethylene |
|---|---|---|---|---|---|---|---|---|
| Name | H2O | KOH | Silicate 40 | Borax | MeOH | Formalin | Glycol | Glycol |
| PB001 | 97.3 | 129.7 | 761.3 | 27.9 | 0 | 0 | 0 | 0 |
| PB002 | 85 | 129.7 | 761.3 | 27.9 | 0 | 0 | 0 | 13.7 |
| PB003 | 28.4 | 129.7 | 761.3 | 27.9 | 44.7 | 0 | 0 | 13.7 |
| PB004 | 12.3 | 129.7 | 761.3 | 27.9 | 44.7 | 22.7 | 0 | 0 |
| PB005 | 40.7 | 129.7 | 761.3 | 27.9 | 44.7 | 0 | 0 | 0 |
| PB006 | 68.9 | 129.7 | 761.3 | 27.9 | 0 | 22.7 | 0 | 0 |
| PB007 | 56.6 | 129.7 | 761.3 | 27.9 | 0 | 22.7 | 0 | 13.7 |
| PB008 | | 129.7 | 761.3 | 27.9 | 44.7 | 22.7 | 0 | 13.7 |
| PB009 | | 129.7 | 761.3 | 27.9 | 44.7 | 22.7 | 11.3 | 0 |

The same part A was used for each and every of the 9 examples:

100 g of W610 ceramic microsphere, 30 g of Metastar 501HP metakaolin, 10 g of Maxfil 104 aluminum tri hydrate, 60g of AC99-20 alpha alumina, 15 of caro white calcium aluminate.

For each sample 135 g of the respective part B was mixed with this mixture of part A. First manually for 5 minutes, then using a Flacktek planetary mixer.

Each sample was then cured in a humidity chamber at 60 C, 30% RH for 24 H (using 89 mm wide cylinders as molds). Sample were then dried at 80 C for 24 h and finally heated to 400 C for 6 H.

FTIR were then performed on every sample. FTIT were performed using a Nicolet IZ10 with a smart ATR attachment (with a single crystal diamond cell).

Normalized section of these FTIR is shown in FIG. 5 for 800-1200 cm-1. The peak of interest that we are observing as 100% intensity is the Si—O-T stretching vibration peak.

For the samples made using PB 01 that does not contain any organic, the peak is centered around 980 cm-1. While the samples with organic containing part B (despite the organics having evaporated/burned off by the heat treatment) this peak top is shifted as far as 940 cm

Discussion: The main peak is the asymmetric stretching vibration peak of Si—O-T species with T=Si or Al. A compound with exclusively Si—O—Si bonds will have the main peak much more to the left (centered at 1100 cm-1). In materials where the Al and Si atoms are not intimately mixed (most bonds are Si—O—Si or Al—O—Al) this peak is split in two (one for the Si species, 1 for the Al species, with a small shoulder for the interface between the 2 regions of the material.

There are several well-defined positions for this peak depending on the number of Al atoms in the next 2 neighbors of a silicon atom and the way the Si—O tetrahedron and the Al—O 4 or 6 coordinated polyhedrons (i.e., the 1 to 3d dimensionality of the network). Such a large shift in the peak top position is indicative that:
1-There is a lot more order in the network: the number of Al neighbors around a Si atom is higher and that ratio varies little. There is almost no region of the network with just Si—O—Si species nor Al—O—Al species.
3-The network is more crosslinked, due to the more homogeneous distribution of Al—O octahedron in the network.

### Examples 10 to 12

DSC runs were made on the materials (Impact Analytical, Midland Michigan Report R170372 DSC and Pyrolysis GC-MS of an AluminoSilicate Formulation included in its entirety herein) on our inorganic polymerization with and without organic solvents. The DSC proved that both the dissolution and condensation reactions speed increased. FIGS. 1 and 3 are geopolymers processed with small polar solvents and FIG. 2 is for the same geopolymer reacted without the small polar solvents. Even more importantly, the DSC proved the reaction product was different from known geopolymers in that the instant product lacked the high temperature crystallization isotherm about 450° C. as was in the geopolymer produced by the reaction without the organic solvent. The difference between the 2 types of network: inhomogeneous cluster of Si—O—Al and cluster of Al—O—Al for non-organic activate\or treated material versus an homogeneous network of Si—O—Al (with a narrow range of Si/Al ratio around each Si atom) cause this important change in this crystallization. This is due to mullite crystalizing at low temperature only in inhomogeneous mix of alumina to silica.

| Sample | Part B type | Part B amount | FlyAsh |
|---|---|---|---|
| 1 | G4.2 | 130 g | 175 g |
| 2 | G4.3 | 130 g | 175 g |
| 2 | G4.4 | 130 g | 175 g |

| Part B type: | G4.2 | G4.3 | G4.4 |
|---|---|---|---|
| Formaldehyde | 2.27 | — | 2.27 |
| (37%) | | | |
| Ethylene glycol | 1.37 | — | 1.37 |
| Methanol | 4.47 | — | 4.47 |
| KOH Flake 1^{st} | 0.31 | 0.31 | — |
| addition | | | |
| NaOH Flake 1^{st} | — | — | 0.22 |
| addition | | | |
| Sodium silicate | 76.13 | 76.13 | 76.13 |
| (40%) | | | |
| Borax (5M) | 2.79 | — | 2.79 |
| KOH Flake 2^{nd} | 12.66 | 12.66 | |
| addition | | | |
| NaOH Flake 2^{nd} | — | — | 9.03 |
| addition | | | |
| Water (distilled) | — | 8.99 | — |

In addition to the HCPC's versatility in terms of manufacturing parts and components from the material itself, the material also has several applications for use in the metal casting industry. The chemical inertness and temperature resistance of the material to 3400° F. allows it to be used to cast both nonferrous and ferrous metals and metal alloys. Due to its high dimensional stability at high temperatures and low reactivity, the material could allow a disruptive innovation in allowing steel to be die cast, currently impossible by conventional means. The tailorable thermal conductivity of the material is of especially great interest for aluminum casting, the faster the aluminum cools from molten to glassy state, the more amorphous the structure and the harder the resulting part. The quickest entry into the market is somewhat less glamorous: pattern casting material for medium to high-volume sand-casting operations. In these operations, sand is blown and/or pressed against a urethane pattern which are typically cast off of metal master. There is a need for a pattern casting material with higher abrasion resistance than urethane, and that can withstand the heat of hot sand mold making, rather than the cold sand required by the thermally labile urethanes. Hot sand making of molds allows considerably more rapid mold creation than cold sand methods.

The HCPC has several readily apparent dimensions of appeal: Its composition can be composed of available refined feedstocks and can optionally include various quantities of USA-sourced technical grade postindustrial waste stream materials, offsetting both bulk material costs and decreasing environmental impact of formulation. It contains no formaldehyde, VOC's, or heavy metals, thus mitigating personnel safety risk. It is potentially amenable to 3D-printing based rapid prototyping and fabrication methodologies; applications include rapid production of both part and molds. When used as a mold, the HCPC material can be tooled quickly in gel state, thereby minimizing machine time and labor expenses. If used as a mold, its high temperature stability and thermal conductivity allows for fast demold times of both cast metals, and sequentially, thermoset/plastics. The same mold can be used to cast multiple material types, including Li—Al alloys, Steel, and as well as organic polymers.

These properties will allow the HCPC material to fulfill several material needs, which include high temperature structural component requirements that do not delaminate or crack, the need for fast turn-around time production methodologies and cross-material scalable design process, the need for low-cost high precision components at medium production scale, the need for ablative/reusable heat shielding, the need for advancements in cast metal process and associated materials, among others. Due to high dimensional stability, the HCPC material can also be used to make molds for casting titanium, steel, as well as lithium-aluminum alloys, and more.

When used as a viscous coating and patch-cured, our HCPC provides a highly temperature resistant, dimensionally stable, hydrophobic, thermal shock resistant coating with tunable electromagnetic absorption/conduction properties and high substrate bond strength. This coating can be applied at room temperature, contains no VOC's, and is environmentally friendly. Low deployment cost and increased durability decreases cost of production and sustainment for current and future LO material coated systems.

The materials of this invention have a lot of potential uses, including: dental implants and plating; speaker housings, bracings, passive/active absorbing interfaces, braces mounts, transducer component; synthetic decking, flooring, and tiling; “ceramic” preforms for investment casting; metal casting molds, cored, dies, patterns, and forms; precast building elements, load bearing and decorative; disc brakes, brake pads, bearings, rotary gaskets; glassblowing molds, pads, handles, tongs, forms, and others; dishware, drinking glasses/cups, plates, platters, bowls; adhesives, coatings, varnish, veneer, polish, stain, colorant; refractory cauldrons, kiln walls, molds, flooring; watch housings, belt buckles, buttons, cufflinks; building compound/binder (cement), bricks, highway sleepers, sidewalk slabs; grills, griddles, smokehouses, cookers, autoclaves; resistive heating elements, thermoelectric components; cast metal tooling and substrate; interleaved metal/ceramic products; cements; solid surfaces such as countertops, bathroom sinks/basins, hot tubs, pools; performance flooring, roofing (continuous), tiles, extruded roofing plates; drivetrains: transaxle, engine components, front drive axle, drive shaft, rear drive axle, rear differential, and engine components; gears, sprockets, bolts, nuts, brackets, pins, bearings, cuffs; engine blocks, fly wheels, turbo fans, compression housings, fuel line connectors; turbine vanes, blades, rotary cores, ignition chambers, exit valves, guide nozzles; drilling shafts, well shield/walls, drill bits; aerospace interiors, arm rests walls, shelves, brackets and more; valves, pump housings, rotors; preforms for glass-to-metal seal; deep drilling rig, teeth, pylons, shaft, related equipment components; bricks, cinderblocks, speed bumps, flooring tiles; battery anode, cathode, housing; plug-in hybrid electric vehicle components, EMF shielding; wheel hubs and components; artificial limb and joint apparatus components; lighting housing, filament, base, bulb components; marine system components and hulls; biological sample gathering and treatment; basins, bowls, and vessels; heat radiation substrate; boats and boat parts; car and car parts; heat/abrasive/caustic/acidic material resistant pipes and linings; fluid and gas tanks; nozzles, bell jars, magnets, blades and abrasives, telecommunications relays, magnetrons, circuits; rings; general health care applications not otherwise mentioned; thermal and electric insulators; covers; microelectronic applications not otherwise mentioned, precast building elements, cast in place building elements, and structural elements applications not otherwise mentioned. Appliance housings, autobody interior and exterior paneling, bridge building and other distance spanning structural components. 3D printed components, structures, process, and elements. Electrical discharge machining heads and other components. “appliance” as in consumer appliance housings, “bridge,” and “autobody” for paneling.

Other possible applications are for prostheses, medical implants, countertops and laboratory tops, consumer electronic housings, industrial and commercial flooring, can coatings, tank linings, pipe coatings and linings, re-bar, EDM milling electrode, and EDM milled parts. The materials of this invention can be used as coatings for various substrates, such as, for example, metals.

What is claimed is:

1. A composition of matter provided by the incipient materials
a) aluminum oxide,
b) silicon oxide,
c) solvent, and a source of
d) divalent cations.

2. A composition of matter as claimed in claim 1 wherein the composition of matter is a gel.

3. The composition as claimed in claim 1 wherein the divalent cations are selected from the group consisting of calcium, and magnesium.

4. A composition of matter as claimed in claim 2, wherein, in addition, fibers are added.

5. A method of preparation of composition of claim 1, said method comprising:
a) providing a mixture of aluminum oxide and silicon oxide;
b) providing a mixture, having a basic pH, in a slurry form, of:
i. water,
ii. a source of OH,
iii. a solvent, and,
iv. a source of divalent cations;
c) mixing A. and B.;
d) exposing the product of C. to a temperature in the range of 160° F. to 250° F. for a period of time to provide a thermoset ceramic.

6. The method as claimed in claim 5 wherein the temperature range is from 175° F. to 225° F.

7. The method as claimed in claim 5 wherein the time period for heating is 2 to 6 hours.

8. A product when prepared by the method as claimed in claim 5.

9. A solid substrate when coated with a composition as claimed in claim 1.

10. A composition of matter consisting of amorphous polymer comprising metal carbon bonds and metal oxide bonds.

11. A composition as claimed in claim 10 wherein the amorphous nature is exhibited by a Raman metal oxide peak between 1300 and 1400 wavenumbers half height full width ratio of greater than 0.12.

12. A method of manufacturing a solid substrate having a protective coating on the surface thereof, said method comprising:
a) providing a first blend of components for forming an inorganic polymer ceramic coating selected from the group consisting of a. dry blends, and b. slurry blends, and;
b) providing a second solution blend of components for forming an inorganic polymer ceramic coating;
c) blending the blend of a) and the blend of b) to form a second slurry;
d) coating a predetermined solid substrate with the blend from the second slurry formed in c);
e) placing the coated solid substrate from d) into a chamber to prevent humidity loss;
f) curing the coated solid substrate at a temperature higher than 25° C. for a predetermined period of time to obtain a solid substrate having a coating on the surface.

13. A coating prepared by the method of claim 12.

14. A solid coated substrate when manufactured by the method of claim 12.

15. The coating as claimed in claim 12 wherein the organic solvents are selected from the group consisting of methanol, isopropanol, ethanol, ethyl acetate, xylene, methyl ethyl ketone, tetrahydrofuran, dimethylsulfoxide, hydrocarbons, terpenes, mineral oil, acetone, and cellosolve.

16. The coating claimed in claim 12 that has a thermal resistance up to 400° F.

17. The coating as claimed in claim 12 having a dynamic coefficient of friction of less than 0.3 against steel.

18. The coating as claimed in claim 12 having a surface emissivity of less than 0.5.

19. The coating as claimed in 12 having a thermal conductivity of lees than 1 W/m² sec.

20. The coating as claimed in claim 12 having an elongation to break greater than 2%.

21. A method of applying the coating as claimed in claim 12 said method comprising applying said coating to a solid substrate.

22. In combination, a tube and a coating as claimed 21, wherein the coating is applied to the interior of the tube.

23. In combination, a tube and a coating as claimed in claim 23 wherein the coating is applied to the exterior of the tube.

24. A coating as claimed in claim 12 wherein the coating has a thickness in the range of 1 micron to 5mm.

25. In combination, a coating as claimed in claim 12 and automotive interior engine components, wherein the automobile interior engine components are coated with said coating.

26. The coating as claimed in claim 12 that is filled with low emissivity filler.

27. The coating as claimed in claim 12 that is filled with low thermal conductivity filler.

28. The coating as claimed in claim 12 that is filled with fiber fillers.

29. The coating as claimed in claim 12 that is filled with low thermal conductivity filler.

30. The coating as claimed in claim 12 having open or closed cell foam characteristics.

31. The coating as claimed in claim 12 which is a two-part system containing composition A and B which undergoes a two-step reaction process, wherein part A is mixed metal oxides, selected from alumina oxide, silicon oxide, magnesium oxide, lithium oxide, calcium oxide, metals, other metal oxides and carbon; wherein part B is a caustic slurry composed of highly alkaline water and solvent selected from the group consisting of methanol, ethanol, a combination of methanol and ethanol, other solvents, reactive amorphous carbon, and chloride salts.

32. A mold tool having a composition comprising Al, Si, C, O amorphous or microcrystalline polymer composite.

33. The mold tool of claim 32 with elongation to break greater than 2%.

34. A process using a two-part system which undergoes a two-step reaction process wherein;
there is a part A that is mixed metal oxides consisting of a metal oxide selected from the group consisting of alumina oxide, silicon oxide, magnesium oxide, lithium oxide, calcium oxide and silicon carbide, and a part B consisting of caustic slurry composed of highly alkaline water and solvent selected from a list consisting of methanol and ethanol.

35. A product as claimed in claim 32 wherein the mold is a solid black cast block.

36. A product as claimed in claim 32 wherein the mold is fiber/polymer layup.

37. A product as claimed in claim 32 wherein a portion of the mold is cast, and a portion of the mold is machined.

38. A process as claimed in claim 32 wherein the mold is:
a) cast on a positive casting frame;
b) hydrogelation reactions occur;
c) a product is removed from the positive casting frame;
d) said product is further shaped, and,
e) said product is finally cured.

39. A process as claimed in claim 32 wherein the mold tool includes an internal exothermal reaction to cause product to cure.

40. Hydraulic fracture proppants manufactured from in organic polymers.
